(19) United States
(12) Patent Application Publication
(10) Pub. No.: US 2014/0110606 A1
(43) Pub. Date: Apr. 24, 2014

(54) NEAR-FIELD OPTICAL DEFECT INSPECTION APPARATUS

(71) Applicant: Hitachi, Ltd., Tokyo (JP)

(72) Inventors: Masaru Furukawa, Tokyo (JP); Junguo Xu, Tokyo (JP)

(73) Assignee: Hitachi, Ltd., Tokyo (JP)

(21) Appl. No.: 14/118,851

(22) PCT Filed: May 27, 2011
(86) PCT No.: PCT/JP2011/062203

§ 371 Date: Nov. 19, 2013

(51) Int. Cl. G01N 21/95

(52) U.S. Cl. CPC G01N 21/9505
USPC 250/492.2

(57) ABSTRACT

A near-field optical defect inspection apparatus according to an aspect of this invention includes a motor, a slider, a slider-moving mechanism, a light source, and a light-collecting probe. The motor rotates an object to be inspected. The slider slides above the rotating object. The slider-moving mechanism supports the slider and moves it above the object rotated by the motor. The light source emits inspection light that irradiates the object rotated by the motor, the inspection light propagating through an internal region of the object to be inspected. The light-collecting probe has an opening, from which the probe collects near-field light due to a defect in the object irradiated with the inspection light. The opening, formed on a surface of the slider that is opposed to the object to be inspected, has a maximal diameter smaller than a wavelength of visible light.

### TECHNICAL FIELD

The present invention relates to apparatuses that use near-field light to detect defects in an object to be inspected. More particularly, the invention concerns a near-field optical defect inspection apparatus that detects internal defects in a to-be-inspected object by use of near-field light induced by the defects.

### BACKGROUND ART

In the silicon wafers (hereinafter, referred to simply as wafers) that are used for semiconductors and solar cells, electrical interconnects and surface shapes tend to be structurally made finer. As this tendency increases, defects as small as from micrometers down to nanometers, such as holes and foreign matter, that are present inside wafers, are causing more significant effects to the functional normality/abnormality and performance of the semiconductor or solar cell.

For this reason, there is a desire to inspect the positions of those small defects in wafers during the manufacture of semiconductors or solar cells. A technique for inspecting defects present inside a wafer, not on a surface of the wafer, is disclosed in Patent Document 1, for example. This existing technique is used to admit infrared light into the wafer and observe through a camera the light scattered from an internal defective region of the wafer.

### PRIOR ART LITERATURE

### Patent Documents

Patent Document 1: JP-1995-239308-A

### SUMMARY OF THE INVENTION

### Problems to be Solved by the Invention

The technique disclosed in Patent Document 1 enables the detection of the defects present inside the wafer, by utilizing infrared-light transmission characteristics of silicon. In this method that uses infrared light, however, in-plane resolution in the wafer is difficult to reduce sufficiently below a wavelength of the infrared light emitted. This method is therefore unsuitable for detecting microscopic defects of a size of several nanometers in wafers.

Additionally, the above method involves placing the wafer on a stage, then moving the stage, and thereby scanning the infrared light across the wafer. This causes mechanical vibration of the apparatus during the driving of the stage, so a distance between the camera and a section of the wafer that is to be measured changes on an order of several micrometers. This is another context in which the above method is unsuitable for detecting microscopic defects of the size of several nanometers in wafers. Furthermore, since moving the stage at a higher speed correspondingly augments the vibration, defect inspection of the entire wafer within a short time is difficult to complete in the above method.

The present invention has been made with the above circumstances in mind, and is mainly intended to inspect accurately a desired object, for example a silicon wafer, for microscopic internal defects, and to reduce the inspection time.

### Means for Solving the Problems

A near-field optical defect inspection apparatus according to an aspect of the present invention includes a motor, a slider, a slider-moving mechanism, a light source, and a light-collecting probe. The motor rotates an object to be inspected. The slider slides above the rotating object to be inspected. The slider-moving mechanism supports the slider and moves it above the object rotated by the motor. The light source emits inspection light that irradiates the object rotated by the motor, the inspection light propagating through an internal region of the object to be inspected. The light-collecting probe has an opening, from which the probe collects near-field light due to an internal defect in the object irradiated with the inspection light. The opening, formed on a surface of the slider that is opposed to the object under inspection, has a maximal diameter smaller than a wavelength of visible light.

### Effects of the Invention

In accordance with an aspect of the present invention, existence of microscopic defects inside an object to be observed can be accurately inspected and a time required for the inspection can be reduced.

### BRIEF DESCRIPTION OF THE DRAWINGS

FIG. 1A is a diagram schematically showing a configuration of a near-field optical defect inspection apparatus according to a first embodiment.

FIG. 1B is another diagram schematically showing the configuration of the near-field optical defect inspection apparatus according to the first embodiment.

FIG. 2A is a diagram schematically showing a configuration of a slider in the near-field optical defect inspection apparatus according to the first embodiment.

FIG. 2B is another diagram schematically showing the configuration of the slider in the near-field optical defect inspection apparatus according to the first embodiment.

FIG. 3A is a diagram schematically showing a configuration of a probe of the slider in the first embodiment.

FIG. 3B is a diagram schematically showing a shape of a microscopic opening formed on the probe of the slider in the first embodiment.

FIG. 3C is a diagram schematically showing another shape of the microscopic opening formed on the probe of the slider in the first embodiment.

FIG. 3D is a diagram schematically showing yet another shape of the microscopic opening formed on the probe of the slider in the first embodiment.

FIG. 3E is a diagram schematically showing a further shape of the microscopic opening formed on the probe of the slider in the first embodiment.

FIG. 4A is a diagram schematically showing another configuration of the probe of the slider in the first embodiment.

FIG. 4B is a diagram schematically showing yet another configuration of the probe of the slider in the first embodiment.

FIG. 5A is a diagram schematically showing another configuration of the slider in the near-field optical defect inspection apparatus according to the first embodiment.

FIG. 5B is another diagram schematically showing the slider configuration in the near-field optical defect inspection apparatus according to the first embodiment.

FIG. 6A is a diagram schematically showing yet another configuration of the slider in the near-field optical defect inspection apparatus according to the first embodiment.

FIG. 6B is another diagram schematically showing the slider configuration in the near-field optical defect inspection apparatus according to the first embodiment.

FIG. 7 is a diagram schematically showing a configuration of a slider in a near-field optical defect inspection apparatus according to a second embodiment.

FIG. 8 is a diagram schematically showing another configuration of the slider in the near-field optical defect inspection apparatus according to the second embodiment.

FIG. 9 is a diagram schematically showing a configuration of a near-field optical defect inspection apparatus according to a third embodiment.

FIG. 10 is a diagram schematically showing another configuration of the near-field optical defect inspection apparatus according to the third embodiment.

### MODE FOR CARRYING OUT THE INVENTION

Embodiments of the present invention will be described below. Parts of the following description and the accompanying drawings are omitted and simplified as appropriate, for clarity of the description. In addition, in each drawing, the same elements are each assigned the same reference number or symbol, and for the sake of descriptive clarity, overlapped description is omitted where necessary.

The embodiments describe inspection of defects in an object to be inspected. More specifically, the embodiments describe examples of inspecting microscopic defects inside a silicon wafer by use of inspection infrared light. While the defect inspection according to the embodiments is particularly suitable for silicon wafers (hereinafter, referred to simply as wafers), the defect inspection can also be applied to other objects to be inspected. An appropriate wavelength of the inspection light is selected according to the kind of material of a wafer to be inspected.

The defect inspection according to the embodiments uses near-field light to detect microscopic defects inside a silicon wafer. To be more specific, defect inspection apparatuses according to the embodiments use infrared light as inspection light to irradiate the wafer. The infrared light has a wavelength that passes through silicon. The infrared light propagates through an internal region of the wafer by repeating total reflection. When the infrared light propagating through the inside of the wafer hits a defect such as a foreign substance or hole, near-field light occurs around the defect. Part of the near-field light exists outside the wafer, in a neighborhood of the wafer surface.

The defect inspection apparatus according to any one of the embodiments supports, above the rotating wafer, a slider having a probe configured to collect the near-field light. The defect inspection apparatus slides the slider (more particularly, the probe of the slider) above the wafer to collect the near-field light that is generated around the microscopic defect inside the wafer, in the neighborhood of the wafer surface and thus to detect the defect in the wafer.

The defect inspection apparatus according to the embodiment rotates the wafer and moves the slider in a radial direction above the rotating wafer. This allows defect inspection of the entire wafer in a short time. To avoid damaging the wafer, the slider preferably flies above the wafer at intervals of a nanometer level (several nanometers to tens of nanometers).

Some specific design conditions may permit the slider to slide along the wafer surface while keeping in contact with the wafer. This will create a very short distance between the defect in the wafer and the probe formed in the slider, and enable appropriate detection of the near-field light generated around the microscopic defect inside the wafer. Some embodiments of nanometer interval near-field light defect inspection apparatuses according to the present invention will be described below referring to drawings.

### FIRST EMBODIMENT

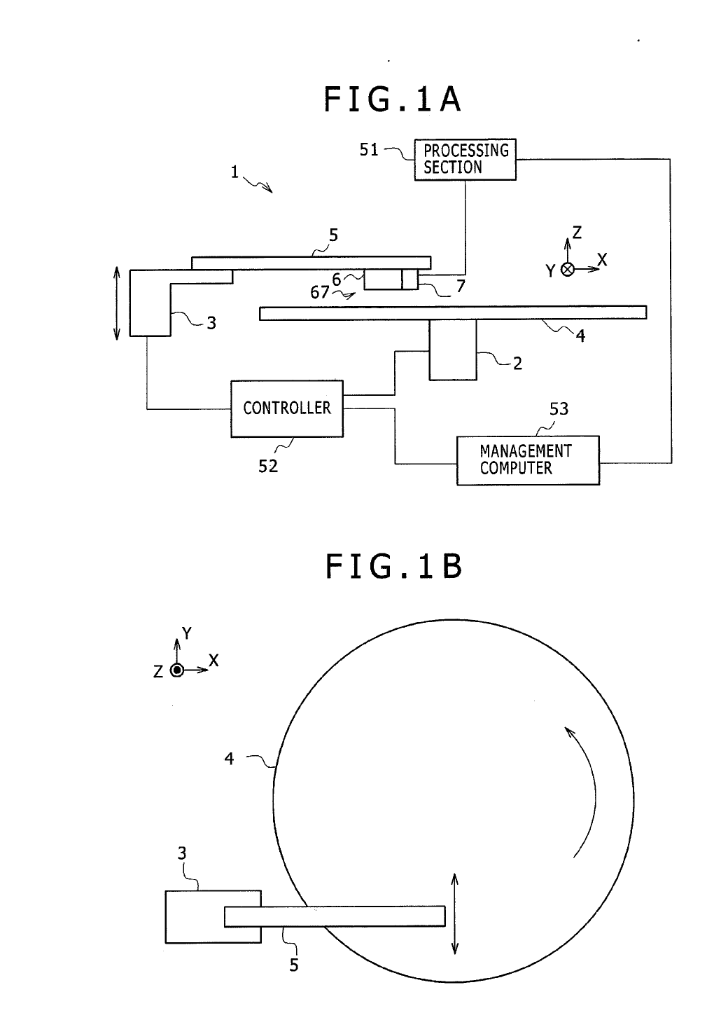

FIG. 1A schematically shows an example of a configuration of a near-field optical defect inspection apparatus 1 according to a first embodiment. For the sake of descriptive convenience, a relationship in dimensions between constituent elements shown in the figure is changed from an actual relationship. Referring to FIG. 1A, X-, Y-, and Z-axes (directions) are defined. The X-axis in FIG. 1A denotes a direction heading from the left of the paper to the right thereof, the Y-axis denotes a direction heading from the front of the paper to the rear thereof, and the Z-axis denotes a direction heading from the bottom of the paper to the top thereof. A relationship between the X-, Y-, and Z-axes and the near-field optical defect inspection apparatus 1 is also maintained on other drawings.

As shown in FIG. 1A, the near-field optical defect inspection apparatus 1 includes a spindle motor 2 that rotates a wafer 4 which is an object to be inspected, and a slider 67 that slides above the rotating wafer 4. In a preferable configuration described below, the slider 67 flies above the wafer 4 at intervals ranging between several nanometers and tens of nanometers.

The wafer 4 is mounted on an upper section of a spindle of the spindle motor 2, and when the spindle rotates, the wafer 4 correspondingly rotates. Typically, the spindle has a rotary disc on which the wafer 4 is mounted. The wafer 4 is fixed to the disc by, for example, a locking part or a vacuum chuck. A mechanism that rotates the wafer 4 may have any arrangement suitable for the rotation of the wafer 4.

The slider 67 includes an approximately parallelepipedic slider body 6 and a stacked element unit 7 formed on the slider body 6. A further detailed configuration of the slider 67 will be described later herein. The slider 67 is supported by a suspension 5. The suspension 5 supports the slider 67 resiliently. The suspension 5 includes a load beam formed of stainless steel, and a gimbal fixed to the load beam. The gimbal is fixed to the load beam by caulking or laser spot welding.

The gimbal is fixed to a surface of the load beam that is opposed to the wafer 4, and the slider 67 is fixed to a surface of the gimbal that is opposed to the wafer 4. The slider 67 is bonded onto the gimbal via an adhesive agent, for example.

The load beam functions as a precise flat spring, generating a downward load against a lifting force of the slider 67. An inflow of air between the slider 67 and the wafer 4 by the rotation of the wafer 4 generates a pressure that causes the slider 67 to fly above the wafer 4. The downward load pressure of the load beam and the lifting force become balanced, which then causes the slider 67 to slide above the wafer 4 while maintaining a predetermined spatial interval.

A surface of the slider body 6 that is opposed to the wafer 4 is formed into a predetermined shape to ensure that the slider 67 slides through a desired flying height and in a desired flying attitude. This surface functions as an air bearing surface, having a precisely engineered shape with projections and depressions. Thanks to an advantageous effect of the air bearing surface, the slider 67 can move above the wafer 4 while maintaining a substantially constant clearance with respect to the wafer 4. Under some specific design conditions, the slider 67 may slide above the wafer surface while keeping in slight contact therewith to such an extent that the wafer 4 does not become worn out when the slider is moved to any position on the wafer. The air bearing surface may be designed referring to a design of a slider used for a hard-disk drive, for example.

The gimbal is a flexible, thin, metallic sheet member easily deformable in comparison with the load beam, and supports the slider 67 while at the same time achieving a free change of the flying attitude of the slider 67 flying above the wafer 4. In the present embodiment, the suspension 5 may have any structure, only if it can appropriately support the flying slider 67. The suspension 5 may be designed referring to the design of a suspension used for a hard-disk drive, for example.

The suspension 5 in FIG. 1A is fixed to a moving support mechanism 3. The moving support mechanism 3 includes a tri-axis stage movable in the directions of the X-, Y-, and Z-axes, and supports the suspension 5 by means of a leading edge of an arm formed on an upper section of the stage. The suspension 5 is fixed to the arm of the moving support mechanism 3.

The near-field optical defect inspection apparatus 1 further has a control and management system including a signal-processing circuit 51, a controller 52, and a management computer 53. The signal-processing circuit 51 processes an electrical signal input from the slider 67, and transmits a resultant signal to the management computer 53. More specifically, the electrical signal is converted from near-field light generated by presence of an internal defect which has been detected in the wafer 4 by the slider 67. Then, the electrical signal is transmitted to the signal-processing circuit 51. The signal-processing circuit 51 then analyzes the signal and notifies the existence of the defect to the management computer 53.

The controller 52 drives and controls the spindle motor 2 and the moving support mechanism 3 in accordance with instructions from the management computer 53. While maintaining the spindle motor 2 to which the wafer 4 is fixed in its rotating or stationary condition, the controller 52 activates the tri-axis stage of the moving support mechanism 3 to move the suspension 5 and the slider 67 above the wafer 4.

The controller 52 can move the slider 67 to any position above the wafer 4 by controlling a movement of the moving support mechanism 3. The controller 52 can identify a current position of the slider 67 above the wafer 4, from a current position of the moving support mechanism 3. The management computer 53 acquires information that indicates the current position of the slider 67 from the controller 52. The management computer 53 can use the defect information from the signal-processing circuit 51 and the slider position information from the controller 52, to identify the existence and position of the defect on the wafer 4.

In addition to the tri-axis stage of the X-axis, the Y-axis, and the Z-axis, the moving support mechanism 3 may include either a biaxis stage of an X-axis and a Y-axis, or a uniaxis stage of one of an X-axis and a Y-axis. In another configuration, the moving support mechanism 3 itself may be a pivotal stage fitted with a turning axis around a Z-axis. In this configuration, the suspension 5 turns in a radial direction of the wafer 4 with a direction of the Z-axis (i.e., a rotational-axis direction of the wafer 4) as a center, thereby enabling the slider 67 to move to any position in a direction perpendicular to the rotational axis of the wafer 4.

FIG. 1B schematically shows the configuration of the near-field optical defect inspection apparatus 1 as viewed from a plus direction of the Z-axis in the first embodiment. As shown in FIG. 1B, the wafer 4 in the present embodiment rotates counterclockwise when seen from the slider 67. In other words, the wafer 4 is rotating in a direction heading from a proximal end of the suspension 5 (i.e., a position at which the suspension is fixed to the moving support mechanism 3), towards a distal end thereof. Accordingly, the slider 67 slides in a direction heading from the distal end of the suspension 5 towards the moving support mechanism 3 in relative fashion with respect to the wafer 4.

As shown in FIG. 1A, the stacked element unit 7 is formed on a trailing end face of the slider body 6. In the flying attitude of the slider body 6, the trailing end face is present at a lower position than other side faces (excluding the face opposed to the wafer). For this reason, the stacked element unit 7 is preferably formed on the trailing end face, but may be formed on any other side face. The above-described rotational direction of the wafer 4 is just an example and the wafer may rotate in an opposite direction. The controller 52 controls the spindle motor 2, thus rotating the wafer 4 at a constant speed or changing this rotating speed.

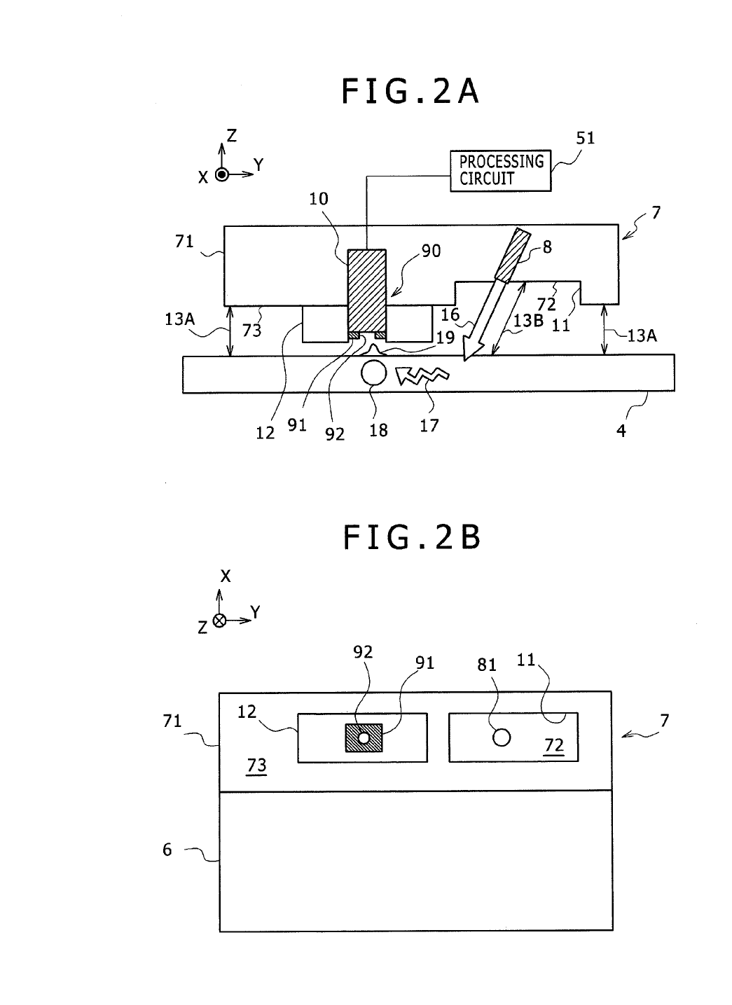

FIG. 2A, which schematically shows details of the stacked element unit 7 and a relationship in position between the stacked element unit 7 and the wafer 4, is a depiction of the stacked element unit 7 as viewed from a plus side of the X-axis. FIG. 2B schematically shows the stacked element unit 7 and a part of the slider body 6 as viewed from a minus side of the Z-axis.

The slider body 6 is formed from a material based upon silicon, AlTiC (aluminum-titanium carbide), or the like. The uneven shape of the air bearing surface of the slider body 6 is omitted in FIG. 2B. As shown in FIG. 2B, the stacked element unit 7 is formed in a stacked condition on the trailing end face of the slider body 6. That is to say, in FIG. 2B, the stacked element unit 7 is formed from a plurality of layers stacked in order from a minus side of the X-axis to the plus side thereof.

Further detailed description of the method for forming the stacked element unit 7 is omitted herein since the forming method does not characterize the present embodiment. While a technique used to manufacture a head slider of a hard-disk drive allows the slider 67 of the present embodiment to be manufactured, any other appropriate method may be used to manufacture the slider 67.

As shown in FIG. 2A, the stacked element unit 7 includes a light-emitting portion 8 that emits infrared light for inspecting the wafer 4 in the present embodiment. The light-emitting portion 8 is, for example, a laser diode. The infrared light has a frequency depending upon a material of the wafer 4, and a frequency of the infrared light used for inspecting silicon is included in a 1,000 nm to 10 μm range, for example.

In the example of FIG. 2A, the light-emitting portion 8, included as alight source in the stacked element unit 7, may include a light-emitting element and an optical waveguide such as an optical fiber. In addition, the light-emitting portion 8 may be disposed on any other face of the slider body 6 or on a part different from the slider 67, for example on the suspension 5. In this case, the stacked element unit 7 will include the optical waveguide, and the light from the light-emitting element will propagate through the inside of the waveguide.

As shown in FIG. 2A, the stacked element unit 7 further includes a light-collecting probe 90 that collects the near-field light 19 generated by the presence of the defect 18 inside the wafer 4. The light-collecting probe 90 in the present embodiment includes a light-receiving portion 10 and a light-blocking film 91. The light-receiving portion 10 includes, for example, an optical fiber and a photoelectric conversion element. The light-receiving element is typically a photodiode. The light receiving portion 10 may not include an active element that converts light into electrical signal form. The light-receiving portion 10 may instead include only an infrared-light waveguide formed from an optical fiber which receives and transmits light. The conversion element in the particular configuration will be disposed on any other face of the slider body 6 or on any other part, for example on the suspension 5.

The light-receiving portion 10 has the light-blocking film 91 attached to its front end. The light-blocking film 91 blocks the infrared light used for inspection. This inspection light usually is visible light. The light-blocking film 91 is formed from an alloy material that contains, for example, gold, silica dioxide, iron, and cobalt. As shown in FIGS. 2A and 2B, an opening 92 is formed in the light-blocking film 91. The near-field light 19 due to the defect 18 enters the light-receiving portion 10 from the opening 92.

The stacked element unit 7 is formed around the light-emitting portion 8 and the light-collecting probe 90, and has an element body 71 internally including these elements. The element body 71 is formed from an alumina-based alloy material that contains metallic impurity elements. The material of the element body 71 in a preferred slider configuration is a material not transmitting the infrared light for inspection, and blocking the light. Additionally, the material of the element body 71 generally blocks visible light.

As shown in FIGS. 2A and 2B, a protrusion 12 is formed around the front end of the light-receiving portion 10. While the light-receiving portion 10 has its front end face shrouded with the light-blocking film 91, except for the opening 92, side faces of the front end of the light-receiving portion 10 are shrouded with the protrusion 12. The protrusion 12 is formed from the same material as, or a material different from, that of the element body 71. The protrusion 12, as with the light-blocking film 91, blocks the infrared light used for inspection, and usually blocks visible light.

A method of detecting the internal defect in the wafer 4 mounted in the near-field optical defect inspection apparatus 1 is described below. The controller 52 controls the light-emitting portion 8, and the infrared light 16 that has exited the light-emitting portion 8 enters the wafer 4. Then, the light inside the wafer 4 is totally reflected to become totally reflected light 17. If a microscopically small defect 18 due to holes or foreign matter is present inside the wafer 4, the totally reflected light 17 changes an angle and near-field light 19 due to the microscopic defect 18 occurs on an upper surface of the wafer 4. The near-field light 19 enters the microscopic opening 92 of the light-collecting probe 90 and is detected by the light-receiving portion 10.

The near-field light 19 that has been detected by the light-receiving portion 10 is converted into an electrical signal within the light-receiving portion 10 and then incorporated into the signal-processing circuit 51 via an electrical interconnect. The signal-processing circuit 51 then conducts processing to calculate intensity of the near-field light 19. Since the near-field light is light that occurs only near an upper surface of microscopically small particles (in the present example, the microscopic defect 18), an ordinary photodiode cannot detect this light. As described in the present embodiment, however, the near-field light due to the microscopic defect 18 can be detected by bringing the microscopic opening 92 into close proximity to the upper surface of the wafer 4.

As shown in FIGS. 2A and 2B, a recess 11 is formed in the element body 71. As shown in FIG. 2B, a light irradiation port 81 of the light-emitting portion 8 is exposed from a base 72 of the recess 11. The infrared light 19 for inspection is emitted from the light irradiation port 81, towards the wafer 4. The recess 11 is surrounded with a wall, and in the present example, a space created by the recess 11 is a rectangular parallelepiped. The recess 11 may have any other shape, and may be farmed into an appropriate shape according to a particular design. For example, at least one of the wall surface and the base 72 may be a curved surface, not a flat surface.

In a preferred configuration, a distance 13B from the light irradiation port 81 of the light-emitting portion 8 to the upper surface of the wafer 4, in a light irradiation direction that the wafer is irradiated with the infrared light for inspection, is greater than the wavelength of the infrared light for inspection. This enables the infrared light for inspection to be propagated through an internal region of the wafer 4. To ensure that the infrared light for inspection is totally reflected inside the wafer 4, an appropriate value is selected as an angle of irradiation of the infrared light for inspection, that is, as an angle of incidence upon the surface of the wafer 4.

To enable the probe 90 to detect the near-field light due to the defect, as the infrared light travels from the light irradiation port towards the wafer surface 4, this light approaches the probe 90 (an irradiation direction vector includes a component heading for the opening 92). As shown in the example of FIG. 2A, the light-emitting portion 8 and the light-receiving portion 10 are arranged in the direction of the Y-axis; the light-receiving portion 10 being positioned above an outer circumferential side of the surface of the wafer 4, and the light-emitting portion 8 above an inner circumferential side thereof.

The relationship in position between the light-receiving portion 10 and the light-emitting portion 8 may be different from the above. For example, the light-emitting portion 8 may be positioned, above the outer circumferential side of the wafer surface, and the light-receiving portion 10 above the inner circumferential side. In another alternative arrangement, these two elements may be close to one another in the X-direction. For example the light-emitting portion 8 may be present above a leading edge, and the light-receiving portion 10 above a trailing edge. In yet another alternative arrangement, the two elements may be disposed obliquely in an X-Y plane.

In the present example, the light irradiation port 81 of the light-emitting portion 8 is formed inside the recess 11. Thus, a distance between a datum surface 73 of the element body 71 and the upper surface of the wafer 4 is reduced and at the same time, a distance between the light irradiation port 81 and the wafer 4 is increased. In a preferred configuration, a maximum distance 13A between the stacked element unit 7 and the surface of the wafer 4, in a region external to the recess 11, that is, the maximum distance 13A between the datum surface 73 and the surface of the wafer 4 is smaller than the wavelength of the visible light. More specifically, the maximum distance 13A is smaller than 360 nm. This short maximum distance reduces stray light that becomes noise and reaches the light-receiving portion 10.

The distance between the wafer surface 4 and the stacked element unit 7 (more specifically, the face of the stacked element unit 7 that is opposed to the wafer) differs according to a particular position of the stacked element unit 7 as well as a particular shape thereof. Typically, while the slider 67 is sliding above the wafer 4, the slider 67 inclines and its trailing edge becomes lower than its leading edge. In addition, the face of the stacked element unit 7 that is opposed to the wafer may have a shape different from that shown in FIGS. 2A and 2B. For example, the opposed face may have a larger number of faces different from each other in depth (height). While defect inspection is being carried out concurrently with infrared-ray irradiation, the above maximum distance between the stacked element unit 7 and the surface of the wafer 4, in the region external to the recess 11, takes a maximum value of all possible distances between the stacked element unit 7 and the surface of the wafer 4, in the region external to the recess 11.

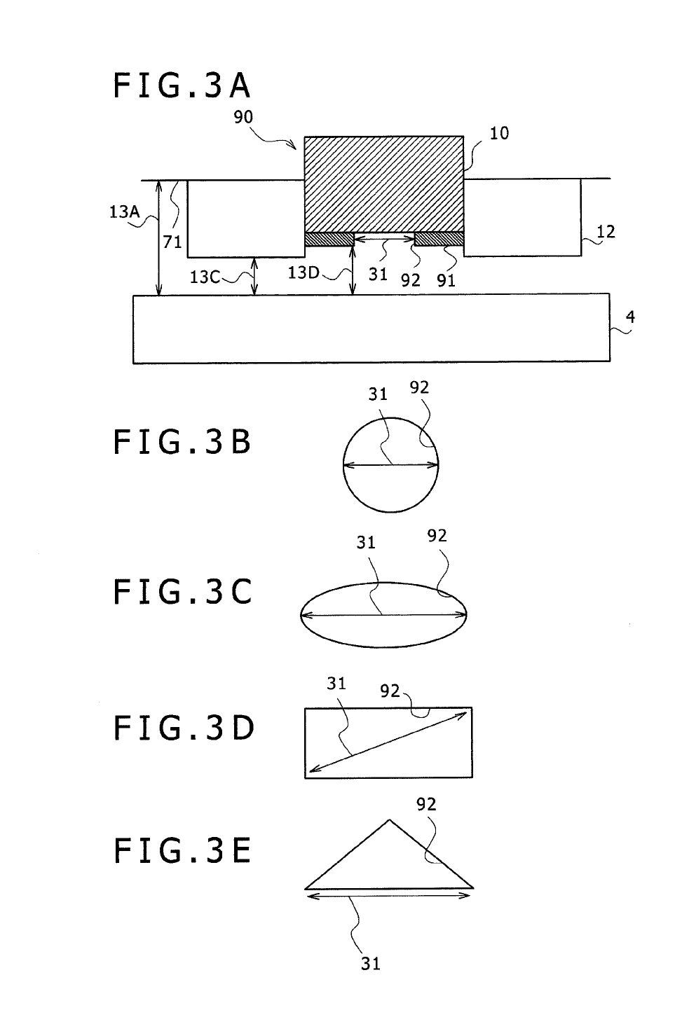

FIG. 3A schematically shows the opening 92 formed on a face of a front end of the light-collecting probe 90 (that is opposed to the wafer), and constituent elements of the probe that are present around the opening 92. Resolution of the near-field optical defect inspection apparatus (near-field optical microscope) is determined by a size of the opening 92, not the wavelength of the infrared light for inspection. The opening 92 is designed so that it has an appropriate size to collect the near-field light due to the microscopic defect, for detection. The opening 92 has a diameter (maximal diameter) 31 smaller than a wavelength of visible light. Specifically, the size is smaller than 360 nm, preferably smaller than 100 nm. This allows appropriate detection of the near-field light due to the microscopic defect.

The opening 92 shown in FIG. 2B is circular in shape. As shown in FIG. 3B, the circle of the opening 92 has a size equal to a diameter of the opening. The opening 92 may have any other shape. For example, the shape may be elliptic as shown in FIG. 3C, rectangular as shown in FIG. 3D, or triangular as shown in FIG. 3E. If the shape of the opening 92 is elliptic, its size 31 is a size of its major axis. If the shape of the opening 92 is rectangular, its size 31 is a length of the longer of two diagonal lines connecting opposite corners. If the shape of the opening 92 is triangular, its size 31 is a length of the longest of three lines which form sides.

Referring back to FIG. 3A, it is important that a distance 13D between the opening 92 and the wafer 4 be small enough for the opening 92 to appropriately collect the near-field light due to the microscopic defect. In a preferred configuration, therefore, the distance 13D between the opening 92 and the wafer 4 is smaller than a maximal diameter 31 of the opening 92.

In the present example, the optical fiber in the front end of the light-collecting probe 90 protrudes from the element body 71 towards the wafer 4. The light-blocking film 91 shrouds the surface of the front end of the probe 90 that is opposed to the wafer, in a region other than the opening 92, but the light-blocking film 91 is not attached to a side face of the front end. As shown in FIGS. 2B and 3A, side faces of the front end are shrouded by the protrusion 12 protruding from the element body 71 towards the wafer 4. As described above, the protrusion 12 blocks the infrared light used for inspection, and visible light.

As shown in FIG. 3A, the front end of the protrusion 12 in a preferred configuration protrudes more than the opening 92 of the light-collecting probe 90 and is positioned close to the wafer 4. This brings the opening 92 of the light-collecting probe 90 close to the wafer 4, while at the same time preventing a collision between the light-collecting probe 90 and the wafer 4. Additionally, the protrusion 12 reduces the stray light that might enter the opening 92 from a peripheral region. In this context, a distance (maximum distance) 13C between the protrusion 12 and the wafer 4 is preferably smaller than a wavelength of visible light, and more preferably, smaller than the size 31 of the opening 92. If the distance 13C differs according to a particular position of the protrusion 12, on a surface of the protrusion 12 that is opposed to the wafer, then the maximum distance is the distance 13C.

As shown in FIG. 2B, the protrusion 12 surrounds periphery of the front end of the light-collecting probe 90 (i.e., front end periphery in the XY plane, a surface opposed to the wafer 4), and this surface opposed to the wafer is rectangular. This, however, does not limit a shape of the protrusion 12. The protrusion 12 may be of a polygonal shape, circle, or any other shape when seen in the direction of the Z-axis, and the surface opposed to the wafer may be a curved one.

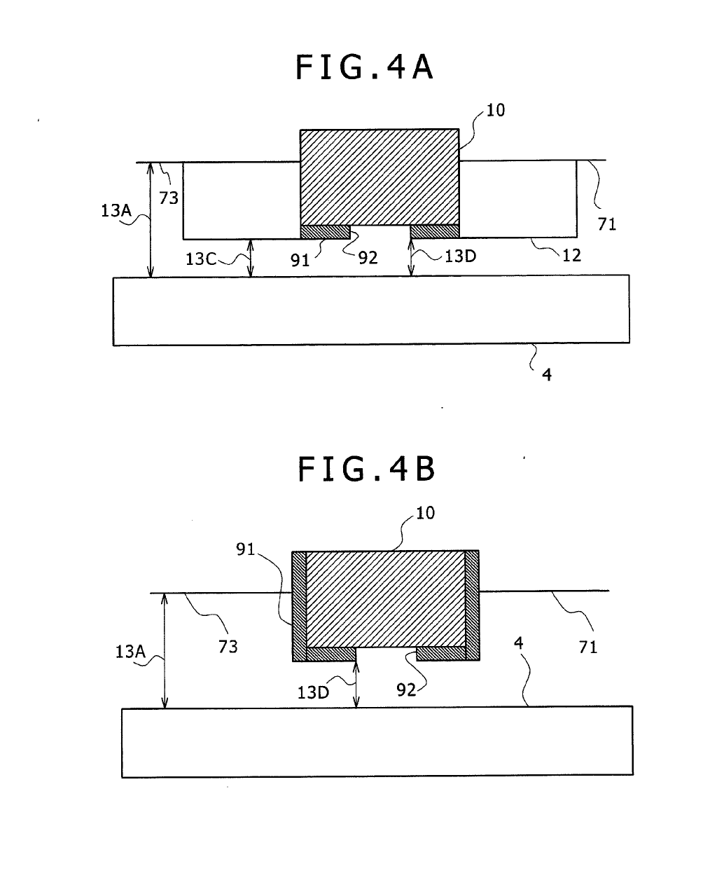

As shown in FIG. 3A, the protrusion 12 preferably protrudes to a position lower than the front end of the light-collecting probe 90 and closer to the wafer 4. Depending upon design conditions, both the front end of the protrusion 12 and that of the light-collecting probe 90 may be flat as shown in FIG. 4A, or the distance 13C between the protrusion 12 and the wafer 4 may be equal to or greater than the distance 13D between the opening 92 in the light-collecting probe 90 and the wafer 4.

Further alternatively, as shown in FIG. 4B, the protrusion 12 may not be formed. Instead, the entire front end of the light-collecting probe 90 protruding from the element body 71 may be shrouded by the light-blocking film 91 including the opening 92. The protrusion 12, although preferably formed so as to surround the entire periphery of the front end of the light-collecting probe 90 in the X-Y plane, may instead be formed to surround a part of the periphery. A region of the light-collecting probe front end that is not shrouded by the protrusion 12 is shrouded by the light-blocking film 91.

The near-field optical defect inspection apparatus 1 may use non-oscillating infrared light 16. For enhanced defect detection accuracy, however, the apparatus may use infrared light that oscillates at specific frequencies. To be more specific, the controller 52 causes an output of the infrared light 16 from the light-emitting portion 8 to oscillate at specific frequencies. The signal-processing circuit 51 extracts only oscillating frequency components using a lock-in amplifier. This extraction further suppresses any impacts of ambient light or other light causing a disturbance.

The light-receiving portion 10, although it includes a combination of an optical fiber and a photodiode, may use any other element capable of detecting light. In addition, although the use of the signal-processing circuit 51 besides the management computer 53 enables high-speed processing as described above, the management computer 53 may execute processing equivalent to that which the signal-processing circuit 51 conducts.

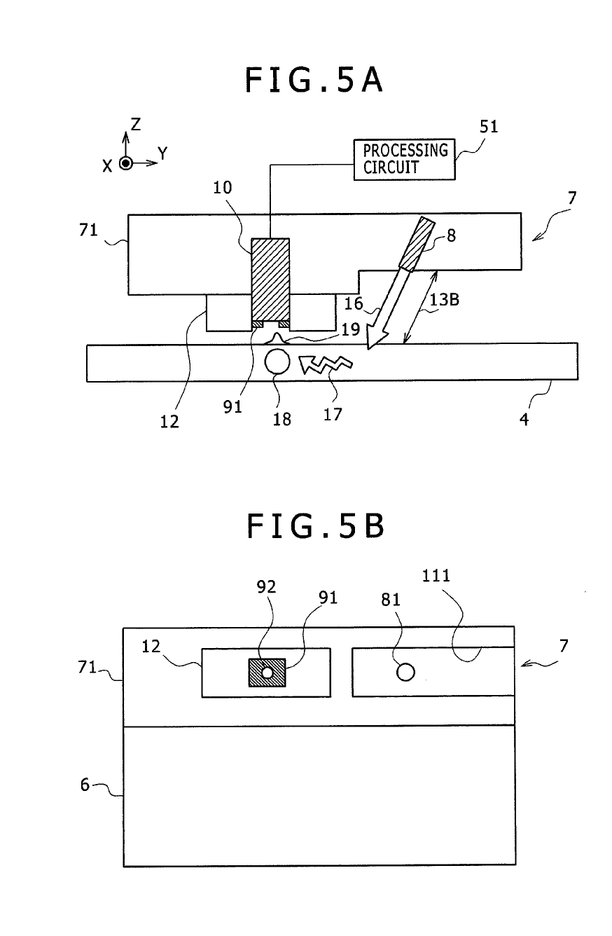

As described above, the light irradiation port 81 of the light-emitting portion 8 is preferably surrounded by a wall and exposed at the base of the recess 11. Unlike this, as shown in FIGS. 5A and 5B, the light irradiation port 81 of the light-emitting portion 8 may be positioned inside the recess 11 extending to an end of the stacked element unit 7. This shape, compared with that adopted in the above example, tends to cause noise and is therefore inferior in effectiveness of preventing ambient light from entering, but makes the stacked element unit 7 easier to work.

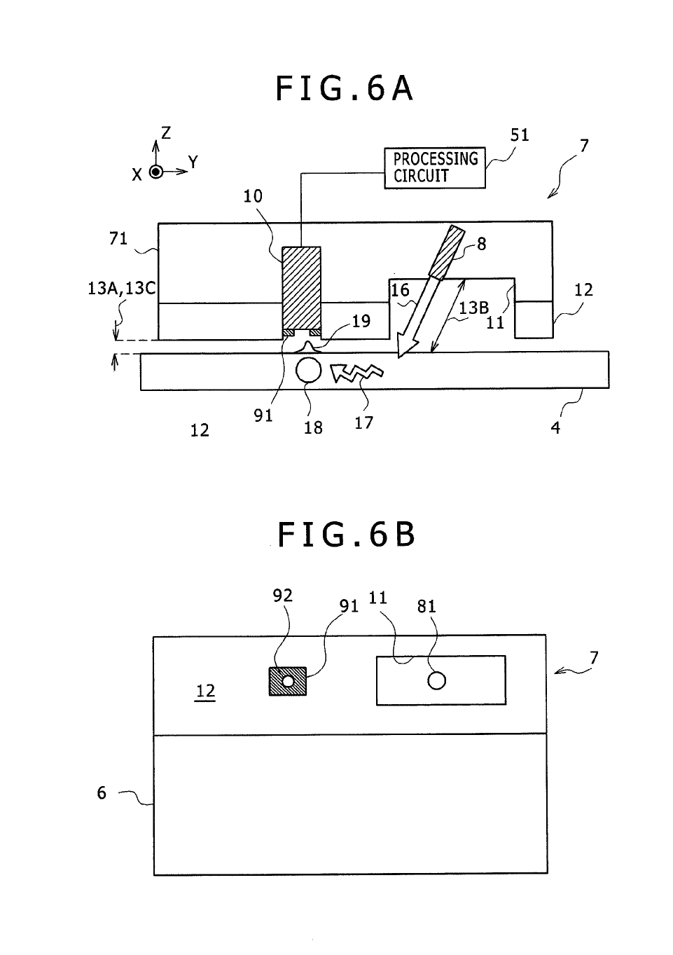

FIGS. 6A and 6B show a further configuration of the stacked element unit 7 by way of example. In this example of configuration, the protrusion 12 extends to both a trailing end of the face of the stacked element unit 7 that is opposed to the wafer (i.e., an end present in a plus direction of the X-axis), and an end present in the Y-axis direction. In the XY plane, the protrusion 12 surrounds the entire periphery of the light-collecting probe 90 and at the same time, further surrounds an entire periphery of the recess 11. The opening 92 in the light-collecting probe 90 exists inside one opening of the protrusion 12, and the irradiation port 81 of the light-emitting portion 8 exists inside the other opening. The configuration shown in FIGS. 2A and 2B is preferable for reduced likelihood of contact between the stacked element unit 7 and the wafer 4, whereas this shape makes the stacked element unit 7 easier to work.

### SECOND EMBODIMENT

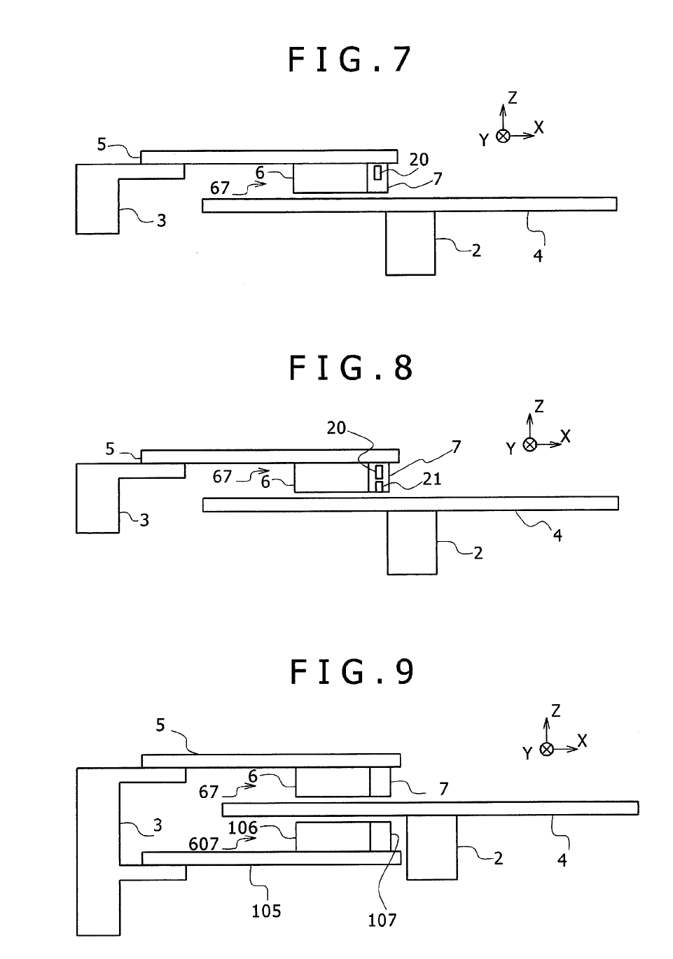

FIG. 7 is a diagram schematically showing a further example of a configuration of the stacked element unit 7 in the near-field optical defect inspection apparatus 1 as a second embodiment. In the second embodiment, the stacked element unit 7 includes a heater element 20. The heater element 20 is a thin-film resistive element formed from permalloy, for example. Other constituent elements are substantially the same as those described in the first embodiment. The heater element 20 is driven and controlled by the controller 52 via a connecting pad provided at the trailing end of the stacked element unit 7.

The controller 52 applies electric power to the heater element 20 from the connecting pad. This heats the heater element 20. The stacked element unit 7 increases in temperature particularly around the heater element 20, and the stacked element unit 7 expands. A section with a microscopic opening 92 expands towards the wafer 4, and a clearance 13D between the wafer 4 and the microscopic opening 92 diminishes.

The controller 52 utilizes this principle and changes the electric power to be applied to the heater element 20. Thus the controller 52 can control and precisely adjust the clearance 13D. A preferred position of the heater element 20 is in a plus direction of a Z-axis when seen from the microscopic opening 9. This positioning locally expands the section provided with the microscopic opening 92 and brings the heater element 20 closer to the wafer 4.

The controller 52, by controlling the heater element 20, maintains a small clearance between the slider 67 and the wafer 4 while executing defect inspection under infrared light irradiation, and increases the clearance after the inspection. Thus the controller 52 controls the clearance between the slider 67 and the wafer 4 accurately and lowers a probability of contact between both. Therefore, the requirements relating to the distances 13A to 13D between the slider 67 and the wafer 4, set forth in the first embodiment, need only to be satisfied while the defect inspection under infrared light irradiation is in progress, and do not need to be satisfied during other time.

FIG. 8 shows a further example of a stacked element unit configuration in the near-field optical defect inspection apparatus 1. The stacked element unit 7 includes a temperature detection element 21 in addition to the heater element 20. The temperature detection element 21 is a thin-film resistive element formed from permalloy, for example. Other constituent elements are substantially the same as those described in the first embodiment.

For example, the controller 52 monitors a resistance value of the temperature detection element 21 via the connecting pad provided at the trailing end. Contact between the slider 67 (including the stacked element unit 7) and the wafer 4 results in heat and causes both the contact section and periphery to rise in temperature. The resistance value of the temperature detection element 21 changes according to the particular temperature. The controller 21 can sense, from the resistance value of the temperature detection element 21, the contact between the slider 67 (including the stacked element unit 7) and the wafer 4.

For early detection of the changes in temperature due to the contact, the temperature detection element 21 is preferably formed in a region neighboring the face of the stacked element unit 7 that is opposed to the wafer. If the stacked element unit 7 includes the heater element 20, in particular, the temperature detection element 21 is preferably formed in a position nearer to the wafer 4 (the face opposed to the wafer) than to the heater element 20.

Upon detecting the contact via the temperature detection element 21, the controller 52 controls other constituent elements to stop the contact. More specifically, the controller 52 either reduces the supply of power to the heater element 20 to increase a distance through which the slider 67 moves upward, or raises the rotating speed of the spindle motor 2 to increase the upward moving distance of the slider 67, or controls the moving support mechanism 3 to move the slider 67 away from above the wafer 4.

The controller 52 can early detect the contact between the slider 67 and the wafer 4, by sensing heat via the temperature detection element 21. In accordance with the sensing of the contact heat by the temperature detection element 21, the controller 52 stops the contact between the slider 67 (including the stacked element unit 7) and the wafer 4, thereby protecting both from damage due to the contact.

The stacked element unit 7 in FIG. 8 includes the temperature detection element 21 and the heater element 20, but may not need to include the heater element 20. Although including the heater element 20 is preferred in terms of flying height control for stopping the contact, the controller 52 can use other methods to stop the contact between the slider 67 and the wafer 4.

### THIRD EMBODIMENT

FIG. 9 schematically shows yet another configuration of the near-field optical defect inspection apparatus 1. This configuration includes two sliders, 67 and 607, used to inspect both surfaces of the wafer 4. More specifically, the near-field optical defect inspection apparatus 1 includes a suspension 5 above the plus side of the Z-axis of the wafer 4, and a suspension 105 above the minus side of the Z-axis.

The suspension 5 supports the slider 67, and the suspension 105 supports the slider 607. The slider 67 has the configuration described in the first or second embodiment. The slider 607 includes a slider body 106 and a stacked element unit 107. The slider 67 and the slider 607 are arranged with the wafer 4 positioned therebetween. It is only necessary that the suspension 105 has substantially the same configuration as that of the suspension 5, and that the slider 607 has substantially the same configuration as that of the slider 67. These elements may each have a different configuration.

The suspensions 5, 105 are fixed to a moving support mechanism 3. The controller 52 can move and position the suspensions 5, 105, that is, the sliders 67, 607, at the same time above and under the wafer 4 by driving and controlling the moving support mechanism 3. The signal-processing circuit 51 processes signals sent from the sliders 67, 607. Since the sliders 67, 607 for defect inspection are provided for upper and lower surfaces, respectively, of the wafer 4, both surfaces can be simultaneously inspected and thus an inspection time can be reduced.

In the configuration shown by way of example in FIG. 9, the suspensions 5, 105 move at the same time and their relative positions are fixed in an XY plane. In addition, typically they are always present at the same position in the XY plane. Unlike this, the moving support mechanism 3 may be configured to move the suspensions 5, 105 independently. During defect inspection, the suspensions 5, 105 may be at either the same position or different positions, in the XY plane.

The configuration shown by way of example in FIG. 9 includes the plurality of sliders for inspecting defects in different surfaces of the wafer 4. The near-field optical defect inspection apparatus 1 may however include a plurality of sliders different from or in addition to the above sliders, for inspecting one surface of the wafer 4 at the same time. The sliders for inspecting one surface of the wafer 4 are placed at different positions in the XY plane. The sliders in the same plane inspect different regions of the wafer surface, so the inspection time required can be reduced. In addition, inspection accuracy can be enhanced since different sliders inspect one region.

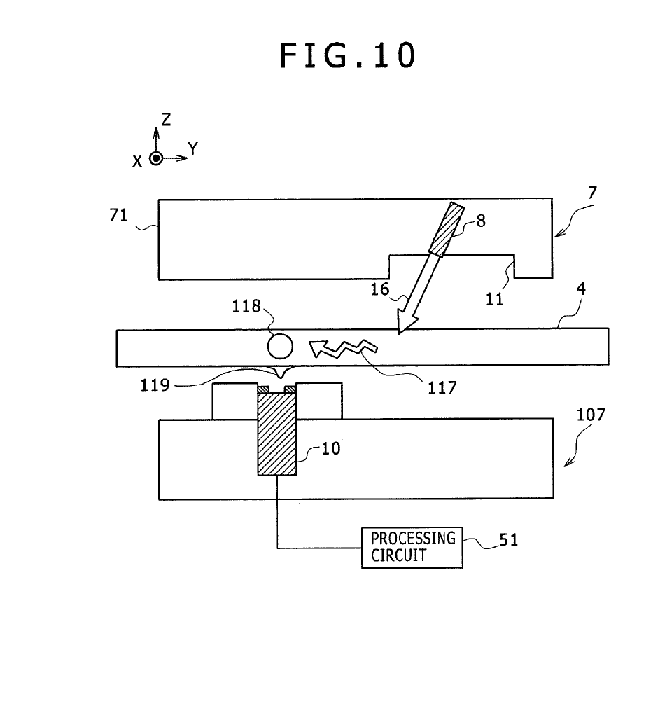

FIG. 10 schematically shows a further configuration of the near-field optical defect inspection apparatus 1. This configuration differs from that of FIG. 9 in the configurations of the respective stacked element units 7 and 107 in the sliders 67 and 607. As shown in FIG. 10, the light-collecting probe 90 as used in each of the stacked element units 7 described in the first and second embodiments is removed and the light-emitting portion 8 as used in each of the stacked element units 107 is also removed.

Infrared light 16 from the light-emitting portion 8 of the slider 67 in the configuration of FIG. 10 is emitted towards the surface of the wafer 4 that is located at the plus side of the Z-axis, and the infrared light propagates through an internal region of the wafer 6 while repeating total reflection. The totally reflected light 117 through the wafer interior enters a defect 118, hence generating near-field light 119. The light-receiving portion 10 of the slider 67 collects the near-field light 119, then converts the collected light into an electrical signal, and transmits the signal to the controller 52.

In this way, infrared light for inspection is emitted from the slider closer to one surface of the wafer 4, and the near-field light due to the defect inside the wafer is detected by the light-receiving portion formed in the slider closer to the other surface. This layout of the sliders renders the configurations of the sliders (stacked element units) simpler and these sections easier to manufacture.

While embodiments of the present invention have been described above, the embodiments do not limit the invention. Any person skilled in the art can easily induce changes, modifications, additions, and the like, in the elements of the embodiments without departing from the scope of the invention.

The plurality of constituent elements disclosed in the embodiments may be combined as appropriate, to form various inventions. For example, several constituent elements may be deleted from all constituent elements shown in one embodiment. In addition, the constituent elements that span different embodiments may be combined as appropriate.

The wafer that has been described referring to the accompanying drawings is a mere example of a circular object (disc) to be inspected, and the invention can also be applied to internal defect inspection of objects having other shapes. As described above, the irradiation port for irradiating a target object with the inspection light is preferably formed in the slider, but the irradiation port may be disposed in other positions.

1. A near-field optical defect inspection apparatus, comprising:
a motor that rotates an object to be inspected;
a slider that slides above the rotating object to be inspected;
a slider-moving mechanism that supports the slider and moves the slider above the object rotated by the motor;
a light source that emits inspection light to irradiate the object rotated by the motor, the inspection light propagating through an internal region of the object; and
a light-collecting probe with an opening formed on a surface of the slider that is opposed to the object to be inspected, the opening having a diameter smaller than a wavelength of visible light, and the probe collecting, from the opening, near-field light due to a defect in the object irradiated with the inspection light.

2. The near-field optical defect inspection apparatus according to claim 1, wherein a distance between the opening in the light-collecting probe and a surface of the object to be inspected is smaller than the diameter of the opening.

3. The near-field optical defect inspection apparatus according to claim 2, wherein:
the slider further includes a protrusion surrounding a front end of the light-collecting probe that includes the opening;
a distance between the protrusion and the surface of the object to be inspected is shorter than the diameter of the opening; and
the protrusion is formed from a material blocking the inspection light.

4. The near-field optical defect inspection apparatus according to claim 3, wherein the distance between the protrusion and the surface of the object to be inspected is smaller than the distance between the opening and the surface of the object to be inspected.

5. The near-field optical defect inspection apparatus according to claim 4, wherein:
the slider includes, on a surface opposed to the object to be inspected, an irradiation port for irradiating the particular object with the inspection light; and
a distance between the irradiation port in a direction of irradiation with the inspection light and the surface of the object is longer than a wavelength of the inspection light.

6. The near-field optical defect inspection apparatus according to claim 5, wherein the slider includes a slider body and an element unit formed on a side face of the slider body, with a recess being formed on a face of the element unit that is opposed to the object to be inspected, and with the irradiation port being exposed at a base of the recess.

7. The near-field optical defect inspection apparatus according to claim 6, wherein:
the element unit includes the light-collecting probe and the irradiation port; and
a maximum distance between the element unit and the surface of the object to be inspected, at a region external to the recess in the element unit, is smaller than the wavelength of visible light.

8. The near-field optical defect inspection apparatus according to claim 7, wherein the element unit further includes a heater that generates heat to expand a surrounding material by the heat and thus to bring the opening of the light-collecting probe closer to the surface of the object to be inspected.

9. The near-field optical defect inspection apparatus according to claim 8, wherein the element unit further includes a temperature detection element at a position closer to the surface of the object to be inspected, than to the heater.

10. The near-field optical defect inspection apparatus according to claim 1, further comprising a second slider, wherein:
the slider-moving mechanism supports and moves the second slider so that the rotating object to be inspected is positioned between the slider and the second slider;
the slider includes, on a surface opposed to the object to be inspected, an irradiation port for irradiating the particular object with the inspection light; and
the second slider includes
a second irradiation port, formed on a surface opposed to the object, for irradiating the object with inspection light, and
a second light-collecting probe with an opening formed on a surface opposed to the object, the opening having a maximal diameter smaller than a wavelength of the inspection light emitted from the second irradiation port, and the probe collecting, from the opening, near-field light due to a defect in the object irradiated with the inspection light from the second irradiation port.

11. The near-field optical defect inspection apparatus according to claim 1, further comprising a second slider, wherein:
the slider-moving mechanism supports and moves the second slider so that the rotating object to be inspected is positioned between the slider and the second slider; and
the second slider includes, on a surface opposed to the object to be inspected, an irradiation port for irradiating the particular object with the inspection light.
